(19) United States
(12) Patent Application Publication
(10) Pub. No.: US 2002/0163860 A1
(43) Pub. Date: Nov. 7, 2002

(54) Audio-recorder alarm clock

(76) Inventor: Frank Raines, Silver Spring, MD (US)

Correspondence Address: Frank Raines, 1711 GlenKarney Place, Silver Spring, MD, 20902, US

(21) Appl. No.: 10/139,752

(22) Filed: May 7, 2002

Related U.S. Application Data
(60) Provisional application No. 60/288,810, filed on May 7, 2001.

(51) Int. Cl. G04B 19/00; G04B 21/00; G04B 25/00

(52) U.S. Cl. 368/274

(57) ABSTRACT

An audio-recorder alarm-clock permits an individual in bed to easily memorialize an audio message without leaving or moving much in bed, with minimal interruption to sleep or falling back asleep.

### RELATED APPLICATION/PRIORITY

Priority is claimed to U.S. provisional application Ser. No. 60/288,810 filed May 7, 2001.

### BACKGROUND OF THE INVENTION

Many alarm clocks are known for accomplishing sleep interruption, often by a loud sound. Because most humans cannot command themselves to awake at a predetermined desired time, alarm clocks are widely used to ensure timely wake-up. Alarm clocks are generally disposed within a few feet of the sleeper, or at least within the same room.

Prior to the predetermined wake-up time for which the alarm is set, generally people want to minimize interruption to their sleep. On the other hand, sleeping, dozing or not-yet-asleep individuals may have a thought or the like that they want to memorialize. Depending on the individual's habits and the urgency of the item to be memorialized, some people may write onto notepads kept by their beds, telephone their own voice-mail with a reminder, record into a memo feature in their telephone or telephone answering machine, record into a tape recorder, or the like. However, conventional methods involve an extra apparatus, such as a tape recorder or a telephone. The set-ups, besides being clumsy and taking space, tend to require attention by the individual, such as concentration in finding a particular button that is not necessarily easily accessible or such as turning on a light. With conventional methods, sleep-time memorializing of information may be accompanied by undesirable costs such as lost sleepiness.

While various improvements have been attempted to a basic alarm clock (see, e.g., U.S. Pat. No. 5,365,494 issued Nov. 15, 1994 to Lynch for “Radio Alarm Clock with Reminder Capability;” U.S. Pat. No. 5,708,627 issued Jan. 13, 1998 to Gormley for “Electronic Clock and Calendar Apparatus with Audio Message Recording and Playback”), the problem of sleep-time memorializing of information has remained to be addressed.

### SUMMARY OF THE INVENTION

It therefore is an object of this invention to provide an alarm clock including an audio recorder. By including an audio recorder in an alarm clock, separate articles that were used for sleep-time information-memorialization (such as telephone answering machines, paper and writing implement, tape recorders, etc.) may be eliminated. A less-cluttered bedside area may be provided.

In one preferred embodiment, the invention provides an audio-recorder alarm clock, comprising: an alarm clock disposed in a housing; an audio recorder disposed in the housing; a record-button, depression of which activates audio-recording via at least one microphone included in the alarm clock in a top or side face; and an audio storage holding the audio-recording until playback is commanded.

As perfecting details are mentioned the following, without the invention being limited thereto. It is particularly preferred that the record-button be easily depressed by a human user reclining in bed. Also it is particularly preferred that at least one recorded audio input is in the audio storage, and/or that at least two recorded audio inputs are in the audio storage.

### BRIEF DESCRIPTION OF THE DRAWINGS

FIG. 1 is a top view of an example of an alarm clock according to the invention.

FIG. 2 is a three-dimensional representational view of an alarm clock according to the invention.

FIG. 3 is a flow-chart of an exemplary audio-memorialization and playback process according to the invention.

### DETAILED DESCRIPTION OF PREFERRED EMBODIMENTS OF THE INVENTION

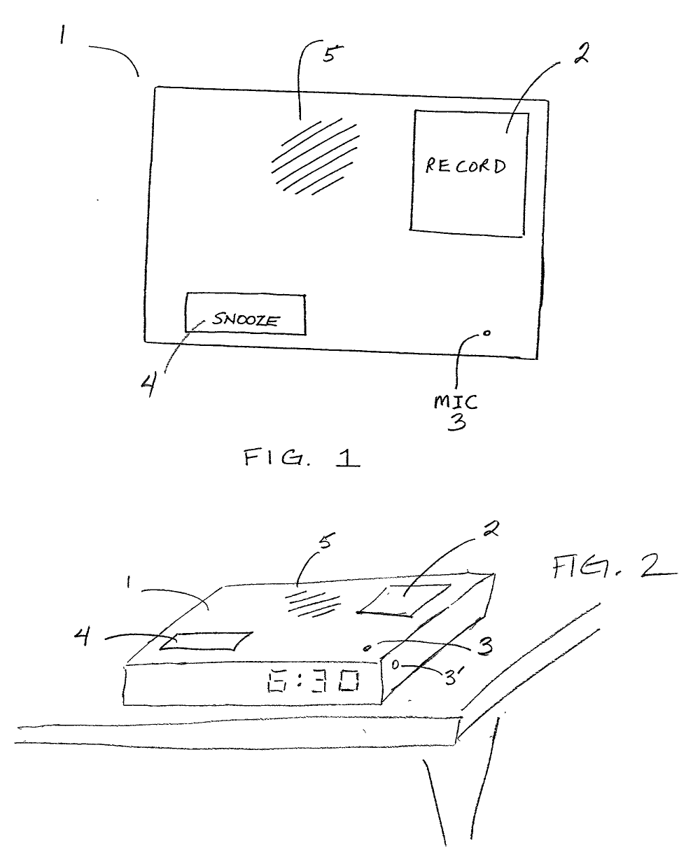

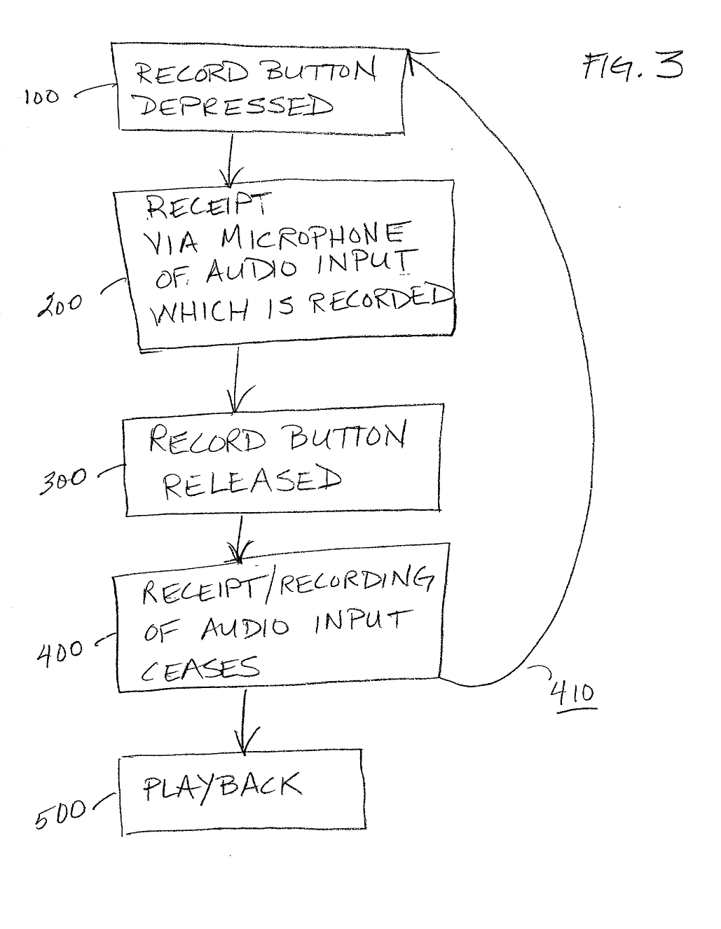

As seen with reference to FIGS. 1 and 2, in a preferred embodiment, the invention on a top face 1 of an alarm clock provides an easily-touch-accessible button (RECORD) 2 to initiate recording. Although optionally the easily-touch-accessible button 2 may be labeled (such as labeled RECORD as in FIG. 1), the button 2 is not required to be labeled and may be unlabeled as button 2 in FIG. 2.

Touching the record button 2 activates a microphone, such that the person may speak and record his or her message without leaving the bed, and most preferably, without even moving much in bed. The microphone may be placed anywhere on or in the alarm clock where a human voice can be recorded with clarity, such as, for example, MIC 3 in FIGS. 1 and 2, microphone 3′ in FIG. 2, etc. The microphone may be sufficiently sensitive that the person speaking may remain inclined and at arms length. The microphone may be disposed on or in the alarm clock housing, such as a microphone (MIC) 3 atop the alarm clock disposed on or in top face 1 as shown in FIG. 1, or on or in a side face of the alarm clock housing, such as microphone 3′ shown in FIG. 2.

The easily-accessible RECORD button 2 and/or the sufficiently sensitive microphone 3 advantageously minimize interruption to a user's sleep mode (such as by permitting eyes to remain closed and posture to remain lying-down). In a preferred embodiment, the invention provides a top panel of an alarm clock in which a recording button 2 is prominently provided, such as a raised, easily-depressed button.

One microphone is shown in FIG. 1, but it will be appreciated that further microphones may be provided. Although the microphone is shown on the top panel of the alarm clock in FIG. 1, the microphone position is not particularly limited and may be on a side panel. At least one microphone is used, and two or more microphones may be used. For example, two microphones may be used, with one microphone placed on each opposite side of an alarm clock, to accommodate the clock being used on one or the other side of a bed. A microphone on the top face of the alarm clock may be used in addition to, or instead of, one or more side microphones.

Although a snooze-button 4 is shown in the example in FIGS. 1 and 2, it will be appreciated that the invention is not limited to snooze-button alarm clocks.

In use, the individual pushes the RECORD button (such as button 2 in FIGS. 1 and 2), and while the RECORD button is pushed down, audio input from the individual is received through the at least one microphone (such as microphone 3 or 3′ in FIGS. 1 and 2) and recorded. Upon releasing the RECORD button, recording ceases, with the audio recording (RECORDED AUDIO 1) being stored for later playback. The audio recording is stored until erased, and erasure cannot be accomplished by pushing the RECORD button alone. By pushing the RECORD button again, a further audio recording (AUDIO RECORD 2) may be made.

FIG. 1 shows a speaker 5 for playing back the recorded audio message(s). The speaker 5 is shown on the top panel in FIG. 1, but it will be appreciated that a speaker may be otherwise disposed. The speaker is not particularly limited and the speaker for audio output may use a speaker that also is part of the alarm clock, or may be used only for the audio playback. The size and location of playback and erase buttons is preferably provided to be relatively less accessible to a sleepy individual than the record button. The playback button is not necessarily required to be a separate button and another alarm clock button may be provided with this further function.

To erase the recorded audio message, preferably a button that could be accidentally activated is avoided. Most preferably, erasure is accomplished by depressing two buttons simultaneously, as RECORD with playback or RECORD with alarm set.

The invention in a preferred embodiment provides a recorder alarm clock comprising an alarm clock and an audio recorder system provided in a single alarm clock housing. As the alarm clock, conventional alarm clocks may be used. As the alarm clock housing, conventional alarm clock housings may be used.

The audio recorder system for use in the invention may be one comprising an audio input sensor, storage for sensed audio input (such as any means for converting sensed audio input into electrical signals with memory means for storing the electrical signals) and audio playback. Preferably, the audio recorder system is button-activated. An audio output device (such as a speaker) is provided. The audio recorder may be digital, such as a system for recording on an IC chip.

In a further embodiment, the invention provides an alarm clock casing, comprising a casing for containing an alarm clock system; and a recording button prominently disposed on the casing exterior. The recording is prominent to a sleep-time individual, such as by being raised, relatively large, and/or illuminated. Also provided on the casing is an erase feature that is relatively low-access. Examples of an erase feature may be a single relatively inaccessible button, or a combination of other buttons. Further provided on the casing is a playback feature.

In a particularly preferred embodiment, an LED display is provided for calling attention to the existence of a recorded audio message.

In FIG. 3, there is shown an exemplary audio memorialization and playback process according to the present invention. A record button (such as button 2 in FIG. 1) on an alarm clock is depressed in step 100, which activates receipt 200 via microphone of audio input which is recorded for later playback, with the recording 200 continuing until release 300 of the record button brings about cessation 400 of receipt/recording of audio input.

Optionally, the user may repeat 410 the recording sequence 100, 200, 300, 400, such as if a user wants to record a second audio message. It will be appreciated that the audio recording device may be selected for having capability to record a sufficient length of message(s) for a typical user, such as no less than a few minutes of recording capability.

As shown in FIG. 3, any audio recording that is made is stored for later playback 500, such as playback when the user awakes from his or her sleep. Most preferably, any audio recording is protected from erasure until playback 500 has been performed, with erasure being accomplished by a command that is not easily accidentally performed. Preferably, erasure for freeing audio recording capacity may be performed shortly after playback, or before bedtime, or at any convenient time for a user.

While the invention has been described in terms of its preferred embodiments, those skilled in the art will recognize that the invention can be practiced with modification.

I claim:

1. An audio-recorder alarm clock, comprising:
an alarm clock disposed in a housing;
an audio recorder disposed in the housing;
a record-button, depression of which activates audio-recording via at least one microphone included in the alarm clock in a top or side face; and
an audio storage holding the audio-recording until playback is commanded.

2. The audio-recorder alarm clock of claim 1, the record-button being easily depressed by a human user reclining in bed.

3. The audio-recorder alarm clock of claim 1, wherein at least one recorded audio input is in the audio storage.

4. The audio-recorder alarm clock of claim 3, wherein at least two recorded audio inputs are in the audio storage.
